(19) United States
(12) Patent Application Publication
(10) Pub. No.: US 2026/0192584 A1
(43) Pub. Date: Jul. 9, 2026

(54) PRINTING APPARATUS AND METHODS OF OPERATING A PRINTING APPARATUS

(71) Applicant: Dover Europe Sàrl, Vernier (CH)

(72) Inventor: Mohammed Toudmeri, Nottingham (GB)

(21) Appl. No.: 19/128,188

(22) PCT Filed: Nov. 8, 2023
(86) PCT No.: PCT/EP2023/081234

§ 371 Date: May 8, 2025

(30) Foreign Application Priority Data
Nov. 8, 2022 (GB) 2216643.3

(51) Int. Cl. B41J 25/316; B41J 2/325; B41J 25/312

(52) U.S. Cl. CPC B41J 25/316; B41J 2/325; B41J 25/312

(57) ABSTRACT

A printing apparatus including a printhead for printing onto a substrate that is moveable in a substrate path adjacent the printhead, a rotary drive device to move the printhead, and a linkage coupling the rotary drive device to the printhead to cause resultant movement of the printhead, the linkage including a first part that is configured to convert rotary motion of the rotary drive device to linear resultant movement of the printhead along a first axis, and a second part that is configured to cause angular resultant motion of the printhead, and a monitoring device for monitoring a force in the second part of the linkage, the force being indicative of a parameter of at least one of the printhead and/or a substrate support against which the printhead is arranged to bear during a printing operation, and a method of operating a printing apparatus.

### FIELD

The present invention relates to improvements to a printing apparatus and methods of operating a printing apparatus. In particular, the invention can be applied to thermal transfer over-printers (TTO).

### BACKGROUND

Transfer printing is well known in the art of commercial printing. In the field of thermal transfer printing, a reel of inked ribbon (also called ‘tape’) is typically mounted onto a spool support. The ink carrying ribbon is transferred along a ribbon path from the supply spool, to the take up spool in a ribbon path, past a printhead which is operable to transfer ink from the ribbon to a substrate.

The printhead may include a plurality of thermally energisable (heatable) printing elements or pixels, which are operable to warm the ink on the ribbon such that it can be removed from the ribbon and transferred to the substrate to form an image, for example data, a pattern, a bar code, QR code, etc. One or both of the supply spool and the take up spool are typically driven in order to transfer the ribbon between the spools. The spool support may be rotatable to transfer ribbon from the first (supply) spool to a second (take up) spool into which ribbon may be wound after and/or during use. The second spool support may also be rotatable. The ribbon can typically be moved in two directions between the spools, i.e., in a forward direction and reverse direction and ribbon is typically transferrable between the spools in both directions, but generally speaking, as ink is removed from the ribbon during successive printing operations, the used ribbon is wound onto the second “take-up” spool, such that the diameter of the supply spool decreases and the diameter of the take-up spool increases. The substrate on to which ink is to be transferred during a printing operation is typically moveable relative to the printhead in a substrate path. Various methods of operation of such a reel to reel ribbon drive are known in the art.

As the inked ribbon is moved through the printing apparatus (between the spool supports), it is passed under the printhead (and the heating elements). During a printing operation, the inked ribbon is sandwiched between the printhead and a substrate on which an image is to be printed. One or more heating elements are heated to melt a portion of ink on the ribbon which is transferred to the substrate to print an image, for example text, a barcode, etc.

There are two principal operating modes-intermittent printing and continuous printing. In intermittent printing, the substrate is advanced to a printing position near to the printhead and then stops, the printhead is then moved relative to the substrate, along an axis substantially parallel to the substrate path, to transfer ink from the ribbon to the substrate to create an image. The substrate then advances to a next printing position. This printing operation process is typically repeated until all required printing operations have been completed, and/or the inked ribbon is depleted and/or the substrate is depleted. In continuous printing, the substrate moves substantially continuously in a substrate path relative to the printhead, whilst the printhead remains in a substantially fixed position (in the direction of the substrate path) relative to a substrate support. In both intermittent and continuous printing modes, the printhead typically moves towards and away from the ribbon and the substrate, between a non-printing position, in which the printhead is not bringing the ribbon into contact with the substrate (or at least not sufficiently close to be able to transfer ink from the ribbon) and a printing position, in which the printhead is in contact with the ribbon and the ribbon is in contact with the substrate (or at least is close enough to transfer ink from the ribbon). In the printing position, the printhead bears against a substrate support, pressing the ribbon into contact with the substrate to transfer ink from the ribbon to the substrate.

The printhead may be moveable substantially orthogonally to the direction of ribbon travel (e.g. along the z axis as shown in FIG. 1), between a retracted or “park” (non-printing) position, a ready-to-print or “prime” (non-printing) position which is closer to the ribbon than the retracted position, and a printing position, in which the printhead is in contact with the ribbon. Typically, a pneumatic actuator has been used to move the printhead between its deployed printing position, and its retracted position(s).

Apart from the infrastructure requirement to deliver compressed air, various studies have shown that efficiency of compressed air systems is in the range of 10% to 15%. Consequently, compressed air actuators are deemed to be more expensive to run in comparison with electrical ones. While there is a high demand for cost-effective actuators, the compressed air solution restricts the TTO market to those factories having compressed air facilities.

Maintaining a substantially constant pressure (force), between the printhead and the substrate (or maintaining the pressure or force within a predetermined range) during a printing operation is desirable as varying pressure can cause a poor quality print.

Embodiments relating to the present disclosure seek to alleviate one or more of the problems associated with known systems.

### BRIEF DESCRIPTION OF THE INVENTION

There is provided a printing apparatus including a printhead for printing onto a substrate that is moveable in a substrate path adjacent the printhead, a rotary drive device to move the printhead, and a linkage coupling the rotary drive device to the printhead to cause resultant movement of the printhead, the linkage including a first part that is configured to convert rotary motion of the drive device to substantially linear resultant movement of the printhead along a first axis, and a second part that is configured to cause substantially angular resultant motion of the printhead, and a monitoring device for monitoring a force in the second part of the linkage, the force being indicative of a parameter of at least one of the printhead and a substrate support against which the printhead is arranged to bear during a printing operation.

The monitoring device may be operable to monitor a parameter that is indicative of one or more of the following:
movement of the printhead;
position of the printhead;
contact of the printhead with the ribbon and/or the substrate support;
a top dead centre position of the substrate support;
a printhead bounce condition;
misalignment of the printhead relative to the substrate support.

The first axis may be substantially perpendicular to a substrate path.

Movement along the first axis may be substantially towards and away from a substrate support configured to support a substrate to be printed.

The first part of the linkage may include one of a ball screw and an eccentric cam arrangement.
the monitoring device may include a strain gauge.

The second part of the linkage may include an arm configured to pivot about a first pivot axis, the first pivot axis being substantially perpendicular to a substrate path.

The printing apparatus may be a thermal transfer printing apparatus.

There is provided a method of operating a printing apparatus including printhead for printing onto a substrate that is moveable in a substrate path adjacent the printhead, a rotary drive device to move the printhead, and a linkage coupling the rotary drive device to the printhead to cause resultant movement of the printhead, the linkage including a first part that is configured to convert rotary motion of the drive device to substantially linear resultant movement of the printhead along a first axis, and a second part that is configured to cause substantially angular resultant motion of the printhead, and a monitoring device for monitoring a force in the second part of the linkage, the method including monitoring a force in the second part of the linkage during a monitoring period, to obtain monitored force data, and using the monitored force data to determine a parameter of at least one of the printhead and a substrate support against which the printhead is arranged to bear during a printing operation.

The method may include determining one or more of the following parameters:
movement of the printhead;
position of the printhead;
contact of the printhead with the ribbon and/or the substrate support;
a top dead centre position of the substrate support;
a printhead bounce condition;
misalignment of the printhead relative to the substrate support.

The monitoring period may include a printing operation.

The method may include a calibration process, including determining reference data indicative of the or each parameter, and storing the reference data in data storage of a controller of the printing apparatus.

The method may include comparing the monitored force with the reference data to determine whether a condition is met.

The method may include using the monitored force data to generate one or more control signals for the drive device, to move the printhead, to carry out one or more printing operations.

The method may include using the monitored force data to identify an error condition, and to generate a response to the error condition.

### BRIEF DESCRIPTION OF THE FIGURES

In order that the present disclosure may be more readily understood, preferable embodiments thereof will now be described, by way of example only, with reference to the accompanying drawings, in which:

FIG. 1 is an illustrative view of a part of a printing apparatus;

FIGS. 2A, 2B and 2C are side views of a printhead assembly in different positions;

FIGS. 3A and 3B show a printhead assemble in different positions relative to a substrate support;

FIG. 4 shows part of a linkage and a printhead;

FIG. 5 is a perspective view of part of a printing apparatus, including a printhead assembly and part of a linkage;

FIGS. 6A and 6B are illustrative side views of an actuator, and a printhead in two different positions, with a monitoring device;

FIGS. 7A and 7B are illustrative side views of an actuator and a printhead in two different positions, with an alternative monitoring device;

FIG. 8 is a perspective view of a printing apparatus with an example of a drive device and a linkage;

FIG. 9 is a perspective view of a printing apparatus with a drive device and an alternative linkage;

FIG. 10 is an illustration of an eccentric cam; and

FIG. 11 is a plot of strain varying with printhead movement.

### DETAILED DESCRIPTION OF THE DISCLOSURE

We provide methods of controlling a printer as described herein, and a printing apparatus configured to operate in accordance with one or more aspects of the methods described.

Various mechanisms and techniques for replacing a compressed air solution are described below. We describe various mechanisms for controlling movement of a printhead, to replace current air-cylinder pneumatic mechanisms, in a printing apparatus.

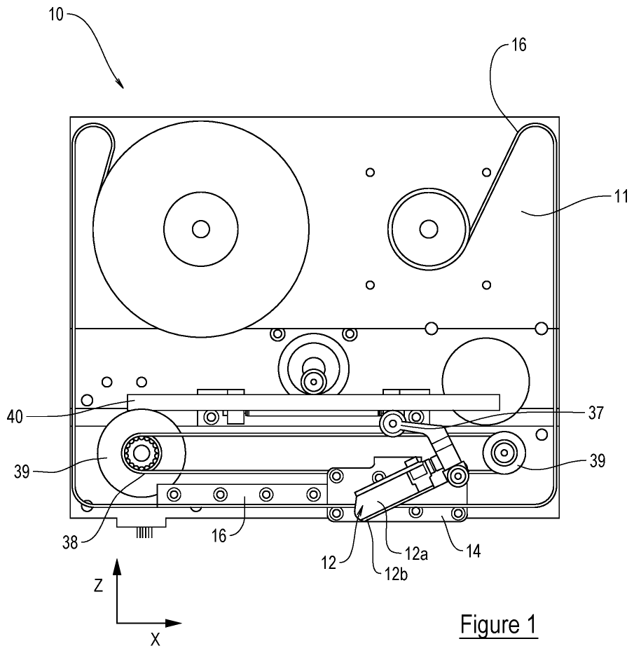

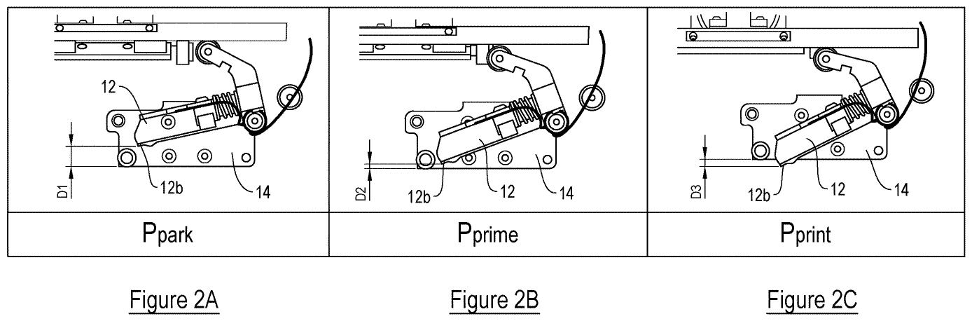

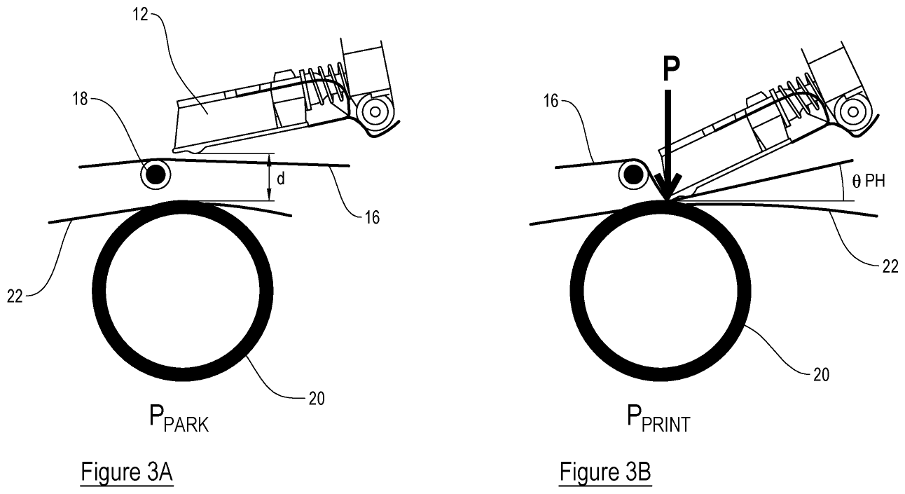

A part of an example printing apparatus 10 is shown in FIG. 1 of the drawings. The printing apparatus 10 includes a body or chassis 11. Components of the printing apparatus 10 may be mounted on the body 11. The printing apparatus 10 includes a printhead 12. The printhead 12 may include a casing 12a and an array of thermal printing elements 12b. The printhead 12 may be moveable substantially linearly and/or angularly between a non-printing position (optionally a plurality of non-printing positions) and a printing position (see FIGS. 2A, 2B, 2C and FIGS. 3A and 3B, for example). A printhead movement arrangement may be provided to move the printhead 12, for example relative to a substrate support 20. The substrate support 20 may be a curved platen roller or a substantially planar surface, for example. The configuration of the substrate surface may depend upon the installation, or application of the printing apparatus 10 and/or the mode(s) of operation, for example intermittent and/or continuous printing operations. The printhead movement arrangement may be configured to move the printhead 12 substantially linearly, for example along the x and z axes (as shown in FIG. 1), e.g. substantially parallel to the ribbon/substrate paths and substantially perpendicularly relative to the ribbon/substrate paths.

The printhead 12 may be moveable between a plurality of discrete positions by the printhead movement arrangement. A first position may be a retracted, parking position P_{PARK} (see FIGS. 2A and 3A). In the first position, P_{PARK}, the printhead 12 may be positioned a first distance D1 away from another part of the printing apparatus measured along the z axis (in FIG. 2A, the distance D1 is the distance between the printing elements of the printhead 12 and a base of a carriage 14 which carries the printhead 12, in FIG. 3A, the printhead 12 is a distance d from a substrate support 20). At the start-up of an operation, ribbon 16 is loaded into the printing apparatus 10, for example using a cassette. At this stage, the printhead 12 may be in the first position, P_{PARK}, away from the peel roller 18 to clear the path for the ribbon 16 during the loading/unloading of the ribbon 16. The park position P_{PARK} is a non-printing position.

A second non-printing position may be set (for example a prime position P_{PRIME}), for example as shown in FIG. 2B. The distance D2 measured along the z axis between a part of the printhead 12, e.g. the printing elements 12b, and the base of the carriage 14 when the printhead 12 is in the prime position P_{PRIME} is smaller than the first distance D1 when the printhead 12 is in the park position P_{PARK}. The distances D1, D2 in the park position P_{PARK} and the printing position P_{PRIME} may be defined as distances between the printhead 12 (e.g. the printing elements 12b) and the substrate support 20, e.g. a printing position of the substrate support 20. Having a second non-printing position is advantageous since the printhead 12 has a shorter distance to travel to carry out a printing operation than if it was necessary to return to the parking position P_{PARK} between every printing operation. A printhead angle θ_{PH} is subtended between the printing elements 12b of the printhead 12 and the substrate support 20. A desired printhead angle θ_{PH} to be subtended during a printing operation is typically specified by the manufacturer of the printhead 12. It is desirable to be able to determine whether the desired printhead angle θ_{PH} is reached. The printhead angle θ_{PH} may vary dependent upon the position of the printhead 12 and vice versa. The printhead angle θ_{PH} may be measured between a part of the printhead 12, for example the printing elements 12b, and a line or plane substantially parallel to the substrate support 20, or a line/plane substantially parallel with a tangent struck at a printing position of a curved substrate support 20, e.g. a top dead centre position of the substrate support 20.

The printhead 12 may be moved towards the ribbon 16 and the substrate support 20 until it touches the ribbon 16. This is a touch position P_{TOUCH}. The printhead movement arrangement continues to move the printhead 12 towards the substrate support, so as to press the ribbon 16 against the substrate 22. A printing position P_{PRINT} is when the printhead 12 is in printing contact with the substrate support 20, i.e. with the ribbon 16 and the substrate 22 pressed together therebetween.

At the end of the pushing stroke (e.g. moving the printhead assembly 12 towards the substrate support 20), the printhead movement arrangement (actuation mechanism) provides an adequate pressure through the printhead assembly 12 onto the ribbon 16, adjacent the substrate 22 and the substrate support 20. The resultant force of this pressure may be adjustable and may be set to anything between 10 to 40N, for example. It is desirable for the selected pressure (force) to be maintained throughout the printing part of the cycle (i.e. when the printhead assembly 12 is in its printing position P_{PRINT}), during which time the printing elements 12b may be energised to print an image on to the substrate 22).

During operation of the printing apparatus 10, the time taken to move between the prime position P_{PRIME} and the printing position P_{PRINT} is typically very short, for example less than 20 milliseconds.

The print part of the cycle could last between 10 ms and 10 s, for example, depending on the size of the image to be printed and the production line speed.

Examples of actuation mechanisms (or “printhead movement arrangements”) are described herein.

The printing apparatus 10 may include a printhead movement arrangement which is operable to move the printhead assembly between the or each printing position and the or each non-printing position.

The printhead movement arrangement may include a drive device, various examples of which will be described below.

The printhead movement arrangement may include a linkage 30 that is configured to couple the printhead 12 to a drive device. The linkage 30 may be operable to convert rotational movement of a drive device into substantially linear movement of the printhead 12 and/or to transmit rotational movement of the drive device to the printhead 12, to cause angular movement of the printhead 12.

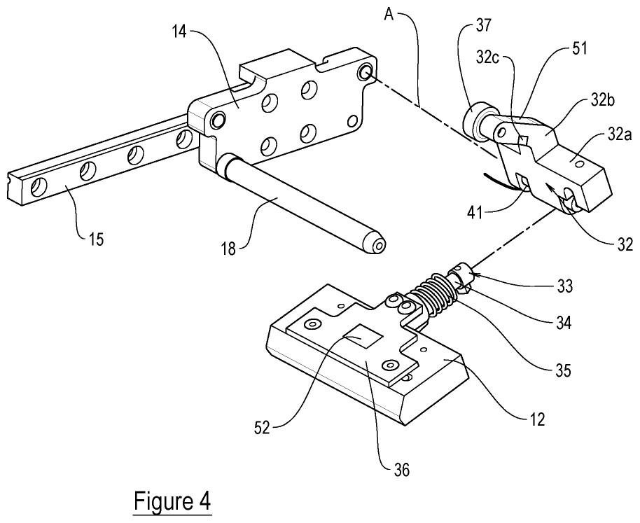

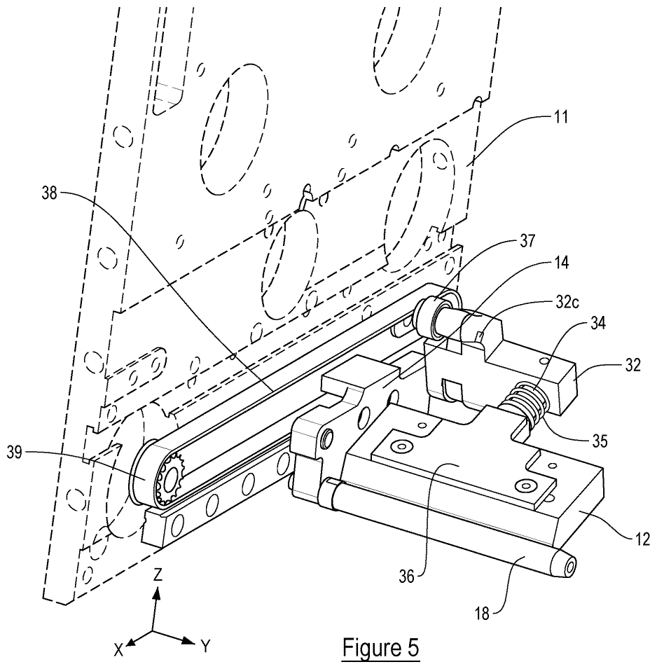

Referring to FIG. 4, the printhead 12 may be mounted on a carriage 14. The printhead 12 may be pivotable relative to the carriage 14, for example about a pivot axis A. The pivot axis A may be substantially perpendicular to the ribbon/substrate path. The printhead 12 may be pivotable about a pivot pin, for example. The carriage 14 may be moveable substantially linearly relative to the body 11 along a first axis, for example along an axis that is substantially parallel to a ribbon and/or substrate path (the x axis as shown in FIG. 1). A carriage guide 16 may be provided for guiding the carriage 14 during movement along the first axis relative to the body 11.

The linkage 30 may include an arm 32. The arm 32 may couple the printhead 12 to the carriage 14. The arm 32 may have a first part 32a and a second part 32b. The second part 32b may be angled relative to the first part 32a.

The linkage 30 may include a connecting assembly 33 for connecting the printhead 12 to the arm 32.

The connecting assembly 33 may include a first connecting member 34. The first connecting member 34 may extend between the printhead 12 and the arm 32. The first connecting member 34 may be connected to the first part 32a of the arm 32. The first connecting member 34 may be connected to the printhead 12, for example to the casing 12a of the printhead 12. The first connecting member 34 may be a rod. The first connecting member 34 may be a pivoting pin.

The connecting assembly 33 may include a biasing member 35 for biasing the printhead 12 into a first position relative to the arm 32. The biasing member 35 may be a spring. The biasing member 35 may be positioned around the first connecting member 34. The properties of the biasing member 35, for example a spring constant, may be known or determined.

The linkage 30 may include a printhead connecting member 36. The printhead connecting member 36 may include a substantially planar portion. The printhead connecting member 36 may be directly attached to the printhead casing 12a. The material properties of the printhead connecting member 36 and/or the casing 12a of the printhead 12 may be known or determined.

The printhead connecting member 36 may yield when the printhead 12 contacts a printing surface 5. Material properties, for example elasticity, of the printhead connecting member 36 may be known or determined.

The linkage 30 may include a first bearing 37. The first bearing 37 may be rotatable. The first bearing may be a ball bearing, for example. The first bearing 37 may be a roller.

The linkage 30 may also include a belt 38. The belt 38 may be arranged in a belt path around belt guides 39. One or more of the belt guides 39 may be rotatable. The bearing 37 may be attached to the belt 38. The carriage 14 may be connected to the belt 38, such that movement of the belt 38 in the belt path may cause substantially linear movement of the carriage 14. The belt 38 may be driven in the belt path, for example by a motor. One or more of the belt guides 39 may be driven, for example. Movement of the printhead 12 substantially parallel to the ribbon path and/or substrate path, e.g. along the x axis may be achieved by moving the belt 38 in the belt path, for example clockwise movement of the belt 38 in the example shown will cause the carriage 14, and hence the printhead 12 to move to the left along the x axis. Anticlockwise movement of the belt 38 in the example shown in FIG. 1 will cause movement of the carriage 14 and the printhead to the right. Movement of the carriage 14 (and the printhead 12) along the X-axis may be used during an intermittent printing mode and/or to align the printhead with a printing position on the substrate support 20 in a continuous printing mode (for example before printing operations begin).

The linkage 30 may be configured to enable the transmission of rotational movement (from the drive device) to the printhead 12. The linkage 30 may be configured to convert rotational movement of a drive device into substantially linear movement of the printhead 12, for example towards and away from the substrate support, e.g. generally along the z axis, and/or to cause angular movement of the printhead 12, which may alter the distance d between the printhead 12 and the substrate support 20 and/or alter the printhead angle θ_{PH}.

A monitoring device 50 may be provided to monitor a force that is indicative of the force exerted by the printhead 12 against the substrate support 20, when the printhead 12 is in the printing position P_{PRINT}. The monitoring device may monitor a force exerted on or by a part of the linkage 30. The monitoring device may be a load cell.

The monitoring device may include a strain gauge 51. The strain gauge 51 may be positioned appropriately to measure a strain indicative of the load (force) exerted by or on the printhead 12.

The strain gauge 51 may be attached to a part of the linkage 30. The strain gauge 51 may be attached to the second part 32b of the arm 32. The second part 32b of the arm 32 may be configured to be more flexible than the first part 32a of the arm 32. The second part 32b of the arm 32 may include an opening or recess 32c. The recess 32c may be positioned opposite the strain gauge 51, such that the strain gauge 51 is operable to monitor strain of the arm 32. The arm 32 plus strain gauge 51 may be configured to act as a load cell.

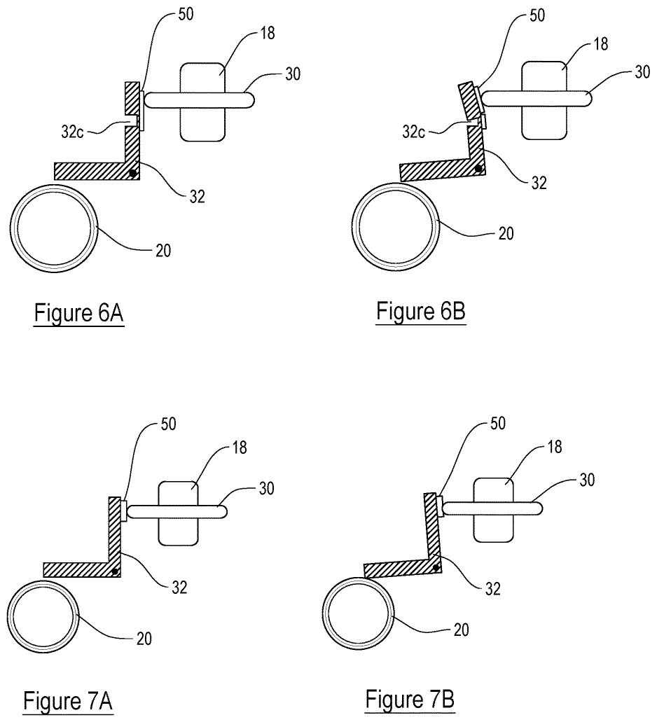

A measurement indicative of force acting on a part of the linkage 30, for example the arm 32 may be indicative of the force being exerted between the printhead 12 and the substrate support 20. This is illustrated in FIGS. 6A and 6B. The linkage 30 is simplified in these figures.

A monitoring device 52 may be positioned on the printhead 12 (or on the printhead connecting member 36).

The or each monitoring device 51, 52 may be operable to determine a measurement indicative of a resultant force between the printhead 12 and the substrate support 20.

Alternative configurations of printhead movement arrangement are disclosed herein.

In the example shown in FIG. 1, the linkage 30 may include a bar 40. The bar 40 may be a swinging bar. The bar 40 may be coupled to a drive device. The drive device may be a rotary drive device. The drive device may be a motor or rotary solenoid, for example. The drive device may be a DC motor or stepper motor, for example.

The bar 40 may be coupled with the bearing 37. The bearing 37 may be spring loaded against the bar 40 by a resilient member 41. The resilient member 41 may be a torsion spring. The resilient member may be configured to maintain the tangency between the bearing 37 and the bar 40. The bearing 37 may enable substantially linear movement of the bar 40 in a direction substantially perpendicular to the ribbon/substrate paths (e.g. the z axis) to cause rotational movement of the arm 32, which may cause rotational (angular) movement of the printhead 12. Angular movement of the arm 32 may cause movement of the printhead 12 towards and away from the substrate support 20 (for example in the z axis). The movement of the printhead 12 may be angular.

The coupling between the drive device and the bar 40 may convert rotational movement into substantially linear movement, for example in a direction substantially parallel to the ribbon/substrate paths, e.g. along the x axis and/or in a direction substantially perpendicular to the ribbon/substrate paths, e.g. along the y axis.

Examples of suitable mechanisms for moving a printhead are set out in more detail below, for example a ball-screw arrangement, and an eccentric cam arrangement. Each arrangement may be suitable for use with a monitoring device (load cell) arrangement as described below.

Electromagnetic solenoids, motor-controlled linkages and cam arrangements may generate a considerable amount of heat while holding (maintaining) the required pressure P exerted by the printhead during a printing operation. An alternative solution may include a ball screw, for example with a shallow pitch, to move and hold the pressure (force) required during a printing part of the cycle.

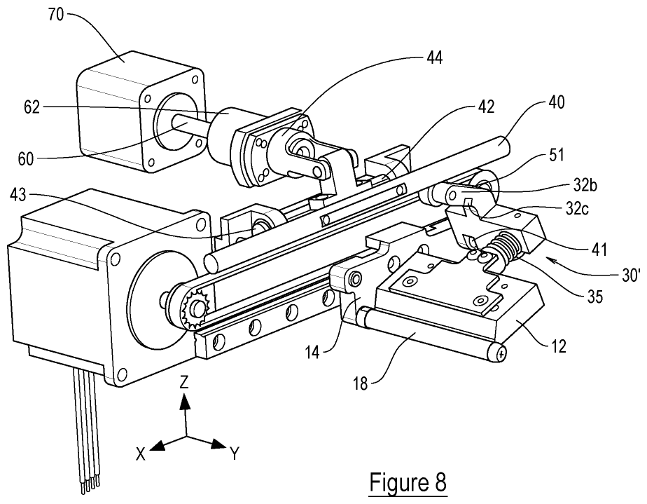

Numeral references provided in the following section refer to the references indicated in FIG. 8.

FIG. 8 shows a printhead movement arrangement including a drive device 70 and a linkage 30′. The drive device 70 may be a motor, for example. The linkage 30′ of the present example includes a ball screw 60. The printhead assembly and the features of the linkage 30 described above are included in the example shown in FIG. 8.

A strain gauge 51 is securely attached to one side of the arm 32 with a recess 32c provided (e.g. cut or machined) on the opposite side of the arm 32 to the strain gauge 51. This is to allow the arm 32 to act as load cell.

The bar 40 may be anchored to a second arm 42. The second arm 42 may be a swivelling arm, that is rotatable about an axle 43. The axle 43 may be a single body or a pair of pivot pins, for example. The linkage 30′ may also include a clevis 44 coupled with the second arm 42. The clevis 44 may be attached to the ball screw 60. The clevis 44 may be attached to a nut 62 of the ball screw 60. Rotation of the ball screw 60 by the drive device 70, causes the ball screw nut 62 and the clevis 44 to move linearly in the Y-direction (substantially perpendicular to the ribbon path and substantially perpendicular to the general axis of movement of the printhead 12 towards and away from the substrate support 20 (z-axis)). The substantially linear movement of the ball screw 60 and the clevis 44 causes the second bar 42 to rotate around the axle 43, moving the first bar 40 in the z-direction—generally towards or away from the substrate support 20. This movement of the first bar 40 against the bearing 37 causes rotation of the arm 32 clockwise or anti-clockwise, which moves the printhead 12 up or down, i.e. towards or away from the substrate support 20.

The ball screw 60 may have a relatively shallow lead angle, so as to convert most of the motor torque into an axial force that is to be maintained during printing by the external frame of the drive device, and requires less holding torque from the drive device 70 (e.g. motor).

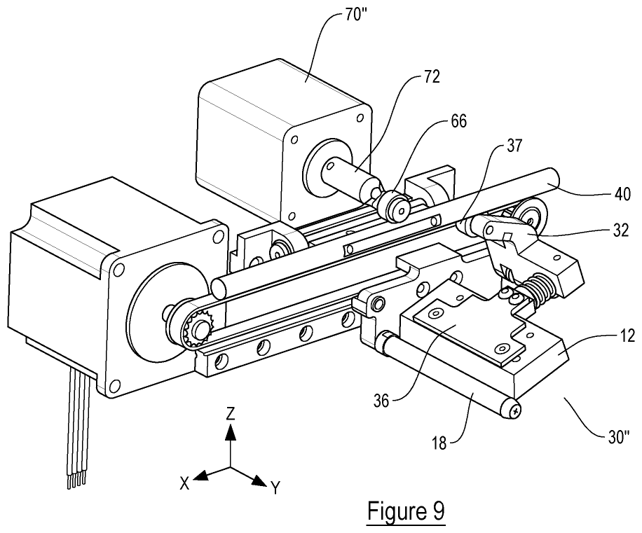

FIG. 9 shows an arrangement of an eccentric cam mechanism for moving the printhead 12. The arrangement of FIG. 9 includes a printhead assembly as described above, and all of the general features described above in relation to the linkage 30.

FIG. 9 illustrates a linkage 30″ and a drive device 70″. The drive device 70″ may be a rotary drive device, for example a motor. The bearing 37 attached to the arm 32 may be biased (e.g., spring loaded) against the first bar 40 by the resilient member 41. This is to maintain the tangency between the bearing 37 and the bar 40. The bar 40 may be anchored tangentially to a second bearing 66. The second bearing 66 may be mounted eccentrically to a shaft 72 of the drive device (e.g. motor) 70″.

By rotating the drive device 70″, the second bearing 66 forces the bar 40 down (substantially linearly in the z-direction, i.e. substantially perpendicularly to the ribbon/substrate paths) and consequently moves the printhead 12 closer to the substrate support 20.

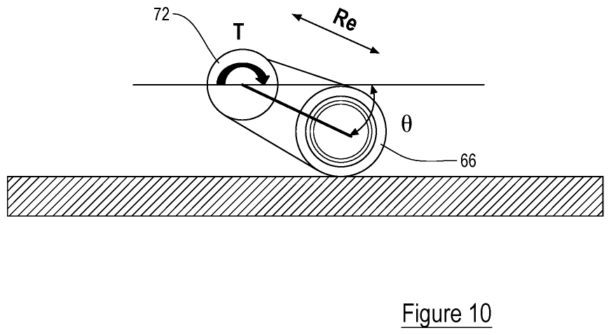

The force F applied on the bar 40 in the z-direction depends on the torque (T) supplied by the drive device 70″, the angle θ of the shaft 72 and the eccentricity radius Re of the eccentric cam (see FIG. 10). The force F may be expressed as follows:

$$F = T * Re * Cos \cdot θ$$

The operation is similar to that as described for the ball-screw arrangement outlined above, but it should be noted that use of an eccentric cam arrangement provides a simplified actuator with an associated reduced cost of production.

We describe the full system used to perform a printing operation, for example a thermal transfer overprint, in continuous and intermittent modes with a fully enclosed control system.

At the start-up of the operation the ribbon 16 is loaded into the printing apparatus 10, for example using a cassette. At this stage, the print head 12 is positioned well away from the peel roller 18 to clear the path for the ribbon during the loading/unloading of the ribbon cassette. We refer to this position as the “print head parking position”. At this position Pₚₐᵣₖ, the biasing member 35 exerts a relatively small torque Tₚₐᵣₖ between the connecting member 34 and the arm 32. This torque may be sensed by the monitoring device 51 strain gauge (load cell) mounted on the arm 32.

The measured torque is used to confirm and inform the operator of the printhead 12 position status. Once the ribbon 16 is in place, the drive device 70 is powered. In the ball screw arrangement, the rotation of the ball screw 60 will drive the connected nut 62, clevis 44, and push the bar 40 to move the printhead 12 towards the substrate support 20. In the eccentric cam arrangement, the second bearing 66 pushes the bar 40 towards the substrate support 20.

The resilient member 41 (e.g. torsion spring) resists this movement of the bar 40 with relatively slow increase in torque (according to Hooke's law):

$$T = - k \cdot θ$$

where T is torque;
k is the torsional constant; and
θ is the angular displacement from an equilibrium position.

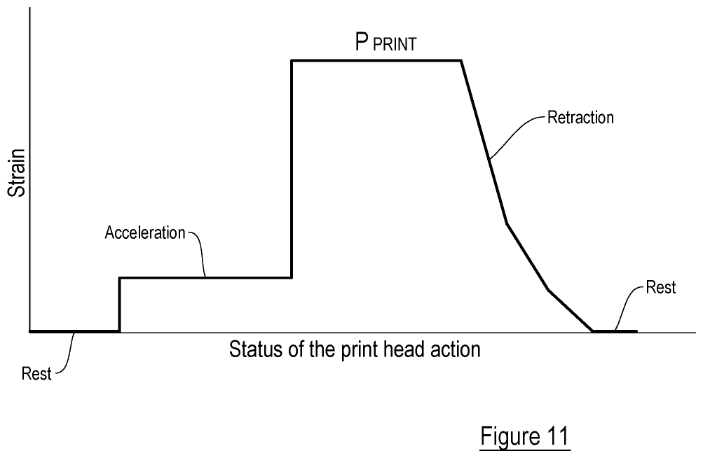

As the printhead 12 travels towards the substrate support 20, it will touch the ribbon 16 first and then close the gap between the ribbon 16 and the substrate 22. As soon as the printhead 12 starts pushing the ribbon 16 against the substrate 22 and the substrate support 20, a sudden change in the load gradient will be sensed and registered by the monitoring device 50 (see FIG. 11 for reference). The point of the change in the torque gradient is noted by the touch position P_{touch} and associated torque by T_{touch}.

The output of the monitoring device 50, for example data indicative of the force exerted by/on the printhead 12 may be passed to a controller of the printing apparatus.

A calibration process may be carried out. During the start-up of the printing apparatus, a teach mode may be used to measure and record resultant printhead pressure versus incrementally increased voltages supplied to the drive device. This relationship can be stored as a look-up table or converted to a pressure function against supplied voltages. This data is used to calibrate (set-up) the voltage required to obtain the desired printhead 12 pressure (force between the printhead 12 and the substrate support 20) during printing, e.g. while the printhead 12 is in the printing position P_{PRINT}.

A printing cycle can be described as follows. The drive device is powered with the selected voltage to rotate and consequently to drive the printhead 12 towards the substrate support 20. As soon as a predetermined force (e.g. the required printing force) is sensed by the monitoring device (e.g. strain gauge 51), the voltage supplied to the drive device can be switched off. The drive device may hold its position during printing by the friction force between the ball screw 60 and associated nut 62, for example. Once the print part of the cycle is completed, the drive device will be powered to move the printhead 12 away from the substrate support 20, for example to rotate the ball screw a number of steps “n” in the opposite direction from the direction moved to cause the printhead 12 to move towards the substrate support 20. This is to retract the printhead 12 back to the prime position Pₚᵣᵢₘₑ. The prime position Pₚᵣᵢₘₑ may be between 0.5 to 2 mm away from the substrate support 20, for example. The printhead 12 will stay in the prime position Pₚᵣᵢₘₑ until a signal is received from the controller to carry out the next print, and so on. At the end of the operation or in the case of emergency, the printhead 12 may be moved further away from the substrate support 20 to the park position Pₚₐᵣₖ, for example in readiness for the cassette removal/replacement and/or other maintenance procedure.

During a printing operation, the monitoring device 51 (e.g. the load cell) may be used to detect, control and maintain the compression between the printhead 12 and the substrate support 20. Using this measurement and control setup, print quality can be adjusted to suit various types of ribbon 16, substrate 22 and/or application/job characteristics. An output of the monitoring device 50, indicative of the force exerted by/on the printhead 12 may be passed to a controller of the printing apparatus, and compared with a predetermined (desired) pressure. The controller may adjust the voltage supplied to the drive device if the difference between the monitored output and a predetermined value indicative of a desired printhead force exceeds a predetermined threshold.

The printing apparatus 10 may be operated in accordance with a series of commands. The controller may control the voltage supplied to the drive device, for example. The commands may be stored in memory of the controller. The or each command may be set in accordance with a calibration process. For example, the controller may determine a series of supply voltages for the drive, each of which corresponds with a position of the printhead 12 relative to the substrate support 20. The controller may perform the routine in an open loop control mode, for example for a predetermined number of repetitions, e.g. to carry out a number of printing cycles, and/or for a predetermined period of time. The controller may additionally or alternatively carry out one or more printing cycles in a closed loop control mode, monitoring the parameter indicative of force exerted by/on the printhead 12 against the substrate support, comparing with a value indicative of a desired force at one or more printhead positions within the cycle, and determining whether the voltage supplied to the drive device should be adjusted, so as to adjust the printhead force. Such closed loop control may be carried out substantially continuously or periodically, for example to determine whether any deviation has occurred, that needs to be accounted for. Stored commands may be updated in response to identifying that the stored command is not producing the desired printhead force (or parameter indicative of the desired printhead force).

Different types of monitoring device 50 can be used to perform and obtain similar results such as beam type, planar beam or full bridge load cells. With some modification on the mechanical assembly, other type of sensors such as pressure pad and Hall Effect sensor can be used to achieve similar results, for example as shown in FIGS. 7A and 7B.

The use of the ball screw solution reduces the energy consumed during the printing part of the cycle. The reduction in the energy consumed will be directly related to friction between the ball screw 60 and the nut 62. The shallower the pitch of the ball screw, the less energy required to hold the drive device in position (and hence maintaining the force exerted by the printhead 12 against the substrate support 20) during the printing part of the cycle. Consequently, less heat is generated in comparison with other solutions.

In each of these examples, the actuator (printhead movement arrangement) is transmitting force to the printhead through a form of arm or cantilever. The quality of the print in thermal transfer printer relies on the pressure applied by the printhead 12 on the back of the ribbon 16 into the substrate 22. We use a strain gauged load cell or pressure gauged solution to monitor this pressure. The printer controller uses the measured pressure to control the force delivered by the actuator.

The load cell on the arm 32 is calibrated, for example during printer manufacture, with a range of loading figures slightly greater than that anticipated to be used during operation of the printing apparatus “in the field”. A look-up table may be stored in the memory of the printer. The look-up table may include forces vs measured voltages across the strain gauge. An illustration of measured strain is provided in FIG. 11.

The load cell arrangement is used to measure, monitor and pass to the printing apparatus controller data for use to control applied forces during the travel of the print head toward the target (acceleration) and as the print head presses against the substrate support 20. Supplied current to the drive device may be modulated and/or adjusted in response to received feedback.

The monitoring device may monitor force data in the linkage during a monitoring period. The monitoring period may include one or more movement phases of the printhead, for example movement between one or more printhead positions, and/or a printing period. The monitoring period may include a rest period. Data obtained during the monitoring period may be force data. The force data obtained may be compared with stored data to determine whether a condition is met.

This arrangement can be used to:
i. confirm the movement of the printhead—the monitoring device may detect load during acceleration/and deceleration of the printhead 12, and this may be monitored by relatively small changes in voltage across the strain gauge, i.e. the output of the monitoring device 50; and/or
ii. confirm the contact between the printhead 12 and the substrate support 20—the measured strain will rise quickly as soon as the printhead 12 presses the ribbon 16 onto the substrate 22; therefore monitoring/detecting a rate of change of output of the monitoring device may be used to monitor when the printhead 12 has touched the ribbon 16 and/or the substrate support 20; and/or
iii. monitor printhead 12 bouncing and consequently perform dampening control (in response to determining a printhead bounce condition, for example)—
   if the printhead 12 hits the substrate support 20 in such a way that a bouncing effect occurs, this means a cyclical strain on the load cell will be exhibited. These bouncing signals can be captured (by monitoring the output of the monitoring device 50). A teach mode may be implemented to predict this bouncing. Current supplied to the printhead movement arrangement may be tuned to damp this behaviour by reducing or increasing the drive device current accordingly or implementing a gentle increase of force (current) as the printhead 12 starts to apply the pressure required; and/or
iv. find a top dead centre of the substrate support—this may be done by
   locking the printhead 12 in a touch position with a curved substrate support 20 and moving substantially tangentially to the substrate support along the X-axis, monitoring the variation in the measured forces- or a signal indicative thereof (the output of the monitoring device)—the force (or signal indicative thereof) is likely to be greatest when the printhead 12 is aligned with the top dead centre position of the substrate support 20; and/or
v. in the case of an intermittent printer (or a printing apparatus operable in an intermittent mode): during installation, the printhead 12 may be moved along the X-axis direction while applying a force against the substrate support 20. In case of a large error of parallelism (misalignment) between the printhead carriage 14 (and/or the printhead 12) and the substrate support 20, the printhead 12 will have to travel further or less far (towards and away from the substrate support 20) as it moves along the X-axis. This variation in the movement would lead to a fluctuation in strain gauge measured forces vs current. This fluctuation may be captured and analysed by the controller and used as feedback to adjust the parallelism between the printer and the platen pad.

The monitoring device 50 may be operable to determine an error condition, for example printhead/substrate support misalignment, too high or too low printhead force, etc. The controller may be operable to generate a response to the error condition, for example to output a signal to a user, e.g. via a user interface—such a signal may include an instruction to adjust the alignment of the printhead 12 and/or the substrate support 20, for example. The controller may generate an automatic response, for example, the controller may generate one or more control signals for the drive device, to adjust the movement and/or position of the printhead 12.

With some variation on the design, a pressure pad can be sandwiched between the driving actuator 30 and the arm 32, or between arm 32 and substrate support 20, as illustrated in FIG. 6A/6B/7A/7B to produce similar results. FIGS. 6A and 6B relate to a print head for which pressure is controlled using a strain gauged arm. FIGS. 7A and 7B relate to an arrangement using a pressure gauged arm.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A printing apparatus including a printhead configured to print onto a substrate that is moveable in a substrate path adjacent the printhead, the printing apparatus further including a rotary drive device configured to move the printhead, and a linkage coupling the rotary drive device to the printhead, to cause resultant movement of the printhead, the linkage including a first part that is configured to convert rotary motion of the rotary drive device to linear resultant movement of the printhead along a first axis, and a second part that is configured to cause angular resultant motion of the printhead, the printing apparatus further including a monitoring device configured to monitor a force in the second part of the linkage, the force being indicative of a parameter of at least one of the printhead and/or a substrate support against which the printhead is arranged to bear during a printing operation.

2. A printing apparatus according to claim 1 wherein the monitoring device is configured to monitor a parameter that is indicative of one or more of the following:
movement of the printhead;
position of the printhead;
contact between the printhead and a ribbon and/or the substrate support;
a top dead centre position of the substrate support;
a printhead bounce condition; or
misalignment of the printhead relative to the substrate support.

3. A printing apparatus according to claim 1 wherein the first axis is perpendicular to the substrate path.

4. A printing apparatus according to claim 1 wherein movement along the first axis is towards and away from the substrate support configured to support the substrate to be printed.

5. A printing apparatus according to claim 1 wherein the first part of the linkage includes one of a ball screw and an eccentric cam arrangement.

6. A printing apparatus according to claim 1 wherein the monitoring device includes a strain gauge.

7. A printing apparatus according to claim 1 wherein the second part of the linkage includes an arm configured to pivot about a first pivot axis, the first pivot axis being perpendicular to the substrate path.

8. A printing apparatus according to any preceding-claim 1, the printing apparatus being a thermal transfer printing apparatus.

9. A method of operating a printing apparatus including operating a rotary drive device to move a printhead configured to print onto a substrate that is moveable in a substrate path adjacent the printhead, wherein the printing apparatus includes a linkage coupling the rotary drive device to the printhead to cause resultant movement of the printhead, the linkage including a first part that is configured to convert rotary motion of the rotary drive device to linear resultant movement of the printhead along a first axis, and a second part that is configured to cause angular resultant motion of the printhead, the method including monitoring a force in the second part of the linkage during a monitoring period, using a monitoring device, to obtain monitored force data, and using the monitored force data to determine a parameter of at least one of the printhead and/or a substrate support against which the printhead is arranged to bear during a printing operation.

10. A method according to claim 9, wherein the method includes determining one or more of the following parameters:
movement of the printhead;
position of the printhead;
contact between the printhead and a ribbon and/or the substrate support;
a top dead centre position of the substrate support;
a printhead bounce condition; or
misalignment of the printhead relative to the substrate support.

11. A method according to claim 9 wherein the monitoring period includes a printing operation.

12. A method according to claim 1 including a calibration process, including determining reference data indicative of the or each parameter, and storing the reference data in data storage of a controller of the printing apparatus.

13. A method according to claim 12, including comparing the monitored force with the reference data to determine whether a condition is met.

14. A method according to claim 9 including using the monitored force data to generate one or more control signals for the rotary drive device, to move the printhead, to carry out one or more printing operations.

15. A method according to claim 9 including using the monitored force data to identify an error condition, and to generate a response to the error condition.

16. A method according to claim 9, wherein operating the printing apparatus comprises performing a thermal transfer printing operation.
